(19) United States
(12) Patent Application Publication
(10) Pub. No.: US 2026/0081554 A1
(43) Pub. Date: Mar. 19, 2026

(54) THERMOPHOTOVOLTAIC (TPV) POWER GENERATOR

(71) Applicant: Hamilton Sundstrand Corporation, Charlotte, NC (US)

(72) Inventors: Debabrata Pal, Hoffman Estates, IL (US); Chad Aaron Springer, Cherry Valley, IL (US); Jason A. Ryon, Carlisle, IA (US); David M. Kucharski, Delavan, WI (US); Urcan Guler, Avon, CT (US); Matthew Gonser, Steward, IL (US)

(21) Appl. No.: 18/889,182

(22) Filed: Sep. 18, 2024

(51) Int. Cl. H02S 10/30; B64D 27/10; B64D 27/35; F02C 6/18

(52) U.S. Cl. CPC H02S 10/30; F02C 6/18; B64D 27/10; B64D 27/35; F05D 2220/60; F05D 2220/76

(57) ABSTRACT

A thermophotovoltaic (TPV) electric power generator may include a hot section configured to receive a portion of high temperature combustion gases via a conduit from a combustion chamber of an engine and receive heat from the combustion gases. An emitter/TPV cell section thermally coupled to the first hot section may be configured to receive and convert heat from the hot section into electric power. The emitter/TPV cell section may include thermal emitting material which ejects/emits photonic particles/energy at given radiative wavelengths and a plurality of TPV cells operable to convert the photonic particles/energy into electric power. Thermally coupled to the emitter/TPV cell section may be a cold section configured to extract heat from the emitter/TPV cell section.

### TECHNICAL FIELD

This disclosure relates generally to electric power generation in an aircraft propulsion system and, more particularly, to a thermophotovoltaic (TPV) electrical power generator for converting redirected expelled engine heat energy to electrical energy.

### BACKGROUND

Modern aircraft propulsion systems typically incorporate a gas turbine engine including a core having, in downstream flow order, a compressor section (with rotor blades and stator blades), a combustion section, a turbine section (with rotor blades and stator blades) coupled to the compressor section via a core shaft or spool, and an exhaust section. During operation, an engine airflow is provided to an inlet of the compressor section where one or more axial compressors progressively compress the air until it reaches the combustion section. Fuel is mixed with the compressed air and burned within the combustion section to provide high-temperature combustion gases (on the order of 1,100° C.) routed from the combustion section to the turbine section. The flow of hot combustion gases through the turbine section drives the compressor section, and the flow is routed through the exhaust section and outward providing thrust (such as core thrust). In some configurations, each of the compressor section and turbine section may include a low pressure (LP) section and a high pressure (HP) section with two separate shafts or spools connecting the respective sections. Other configurations may include a bypass fan or open rotor, which rotates and generates a bypass airflow stream that provides additional thrust (such as bypass thrust) for the gas turbine engine. Large amounts of energy in the form of heat is expelled during the combustion/propulsion process and essentially wasted to the surrounding environment of the engine. If this heat/energy could be harnessed, it has the potential to supplement aircraft electric power requirements.

### SUMMARY

This disclosure provides a thermophotovoltaic (TPV) electrical power generator for converting heat energy to electrical energy.

In a first embodiment, there is provided a thermophotovoltaic (TPV) electric power generator that may have a first hot section configured to receive combustion gases from a combustion chamber of an engine and receive heat from the combustion gases. A first emitter/TPV cell section thermally coupled to the first hot section may be configured to receive and convert heat from the first hot section into electric power. The first emitter/TPV cell section may include a plurality of thermal emitters configured to emit photonic energy and a plurality of TPV cells configured to receive and convert the photonic energy into electrical power through a series of junctions. A first cold section may be thermally coupled to the first emitter/TPV cell section and configured to extract heat from the first emitter/TPV cell section.

Any single one or any combination of the following features may be used with the first embodiment.

The first hot section may include a first conduit configured to transport the combustion gases therethrough, each of the plurality of thermal emitters may be configured to emit photonic energy in response to thermal excitation at a bandgap within an electromagnetic spectrum that is within an operating bandgap range of the plurality of TPV cells, and the first cold section may include a second conduit configured to transport heat exchange fluid therethrough.

The first hot section, the first emitter/TPV cell section, and the first cold section may form a first thermoelectric stack, and the TPV electric power generator may further include a second thermoelectric stack having a second hot section configured to receive combustion gases and receive heat from the combustion gases and a third conduit configured to transport the combustion gases therethrough, a second emitter/TPV cell section thermally coupled to the first cold section and the second hot section and configured to receive and convert heat from the second hot section into electric power, and the second emitter/TPV cell section may include a plurality of thermal emitters and a plurality of TPV cells, and may be thermally coupled to the second conduit of the first cold section.

The first hot section, the first emitter/TPV cell section, and the first cold section may form a first thermoelectric stack, and the TPV electric power generator may further include a second thermoelectric stack having a second emitter/TPV cell section thermally coupled to the first conduit and configured to receive and convert heat from the first hot section into electric power, and may include a plurality of thermal emitters and a plurality of TPV cells, and a second cold section thermally coupled to the second emitter/TPV cell section and configured to extract heat from the second emitter/TPV cell section and may include a third conduit configured to transport heat exchange fluid therethrough.

The first hot section, the first emitter/TPV cell section, and the first cold section may form a first thermoelectric stack, and the TPV electric power generator may further include a second thermoelectric stack having a second hot section configured to receive combustion gases and receive heat from the combustion gases, a second emitter/TPV cell section thermally coupled to the second hot section and configured to receive and convert heat from the second hot section into electric power, and may include a plurality of thermal emitters and a plurality of TPV cells, and a second cold section thermally coupled to the second emitter/TPV cell section and configured to extract heat from the second emitter/TPV cell section.

The first cold section of the first thermoelectric stack may function as the second cold section of the second thermoelectric stack.

The first hot section of the first thermoelectric stack may function as the second hot section of the second thermoelectric stack.

In a second embodiment, there is provided an electric power generating system having a gas turbine engine and a thermophotovoltaic (TPV) electric power generator. The gas turbine engine may include a combustion chamber configured to generate and output a first flow of combustion gases through a combustion gas conduit and a second flow of combustion gases. The TPV electric power generator may include a first hot section configured to receive via the combustion gas conduit the first flow of combustion gases and receive heat from the combustion gases, a first emitter/TPV cell section thermally coupled to the first hot section and configured to receive and convert heat from the first hot section into electric power and may include a plurality of thermal emitters comprising a spectrally selective material and configured to emit photonic energy and a plurality of TPV cells configured to receive and convert the photonic energy into electrical power, and a first cold section thermally coupled to the first emitter/TPV cell section and configured to extract heat from the first emitter/TPV cell section.

Any single one or any combination of the following features may be used with the second embodiment.

The first hot section may include a first conduit configured to transport the combustion gases therethrough, each of the plurality of the thermal emitters may be configured to emit photonic energy in response to thermal excitation at a bandgap within an electromagnetic spectrum that is within an operating bandgap range of the plurality of TPV cells, and the first cold section may include a second conduit configured to transport heat exchange fluid therethrough.

The first hot section, the first emitter/TPV cell section, and the first cold section may form a first thermoelectric stack, and the TPV electric power generator may further include a second thermoelectric stack having a second hot section configured to receive via the combustion gas conduit the first flow of combustion gases and receive heat from the combustion gases and may include a third conduit configured to transport the combustion gases therethrough, a second emitter/TPV cell section thermally coupled to the first cold section and the second hot section and configured to receive and convert heat from the second hot section into electric power and may include a plurality of thermal emitters and a plurality of TPV cells with the second emitter/TPV cell section thermally coupled to the second conduit of the first cold section.

The first hot section, the first emitter/TPV cell section, and the first cold section may form a first thermoelectric stack, and the TPV electric power generator may include a second thermoelectric stack having a second emitter/TPV cell section thermally coupled to the first conduit and configured to receive and convert heat from the first hot section into electric power and may include a plurality of thermal emitters and a plurality of TPV cells, a second cold section thermally coupled to the second emitter/TPV cell section and configured to extract heat from the second emitter/TPV cell section and may include a third conduit configured to transport heat exchange fluid therethrough.

The first hot section, the first emitter/TPV cell section, and the first cold section may form a first thermoelectric stack, and the TPV electric power generator may include a second thermoelectric stack having a second hot section configured to receive via the combustion conduit the first flow of combustion gases and receive heat from the combustion gases, a second emitter/TPV cell section thermally coupled to the second hot section and configured to receive and convert heat from the second hot section into electric power and may include a plurality of thermal emitters and a plurality of TPV cells, and a second cold section thermally coupled to the second emitter/TPV cell section and configured to extract heat from the second emitter/TPV cell section.

The first cold section of the first thermoelectric stack may function as the second cold section of the second thermoelectric stack.

The first hot section of the first thermoelectric stack may function as the second hot section of the second thermoelectric stack.

A cooling system configured to receive heat exchange fluid from the first cold section, lower a temperature of the heat exchange fluid to generate cooled heat exchange fluid, and supply the cooled heat exchange fluid to the first cold section.

The gas turbine engine may include a core engine defining an engine airflow path, and the core engine may include a spool section having a compressor, a combustion section with the combustion chamber, a turbine, and a spool shaft coupled to the compressor and the turbine.

The gas turbine engine may include a spool section having a compressor, a combustion section with the combustion chamber, a turbine, and a spool shaft coupled to the compressor and the turbine, and the combustion chamber may be configured to generate the second flow of the combustion gases and output the second flow of combustion gases to the turbine.

In a third embodiment, there is provided a method including generating combustion gases in a combustion chamber of an engine, diverting a first portion of the generated combustion gases from the combustion chamber, receiving the first portion of generated combustion gases, receiving heat from the received first portion of generated combustion gases, converting, by a plurality of thermophotovoltaic (TPV) devices, received heat from the received first portion of generated combustion gases into electric power, and extracting heat from the plurality of TPV devices.

Any single one or any combination of the following features may be used with the third embodiment.

The method may further include emitting photonic energy from a thermal emitting material in response to thermal excitation caused by heat received from the received portion of generated combustion gases, and converting the emitted photonic energy into electric power.

Extracting heat from the plurality of TPV devices may include receiving heat exchange fluid that contains heat extracted from the TPV devices, lowering a temperature of the received heat exchange fluid to generate cooled heat exchange fluid, and supplying the cooled heat exchange fluid to remove additional heat from the TPV devices.

These and other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description, taken in conjunction with the accompanying drawings, in which:

FIG. 1 is a schematic cross-sectional view of an example aircraft propulsion system according to the present disclosure;

FIG. 2 is a schematic diagram of the aircraft propulsion system with an electric power generating system according to the present disclosure;

FIGS. 3A and 3B are side and cross-sectional views of an example TPV generator in accordance with the present disclosure; and

FIGS. 4A and 4B are right and left perspective side views illustrating two adjacent TPV stacks within the TPV generator according to the present disclosure.

### DETAILED DESCRIPTION

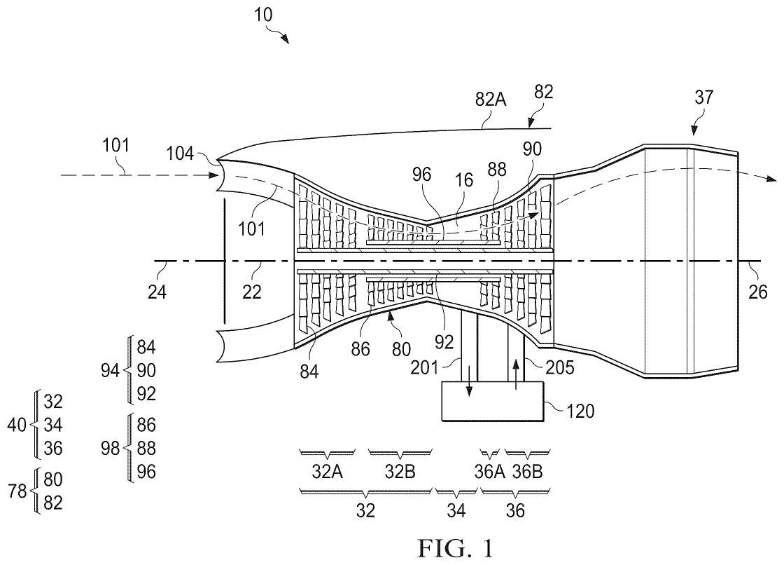

FIGS. 1 through 4B, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

Electrical power for use in aircrafts and aircraft systems is typically generated via a mechanical system including a drive shaft and gearbox that drive a conventional electric generator. The present disclosure and the example systems and devices disclosed here reduce or eliminate the need for mechanically-driven electrical generators and related components. The disclosed systems and devices for generating electrical power from heat in an aircraft system include a thermoelectric generating system having a heat source (such as a flow of high-temperature combustion gases), a heat sink (such as a cooling system), and one or more thermoelectric devices for converting heat from the heat source into electrical power (such as for immediate use or storage in a battery). In some embodiments, the thermoelectric devices may be thermophotovoltaic (TPV) devices that can convert heat (thermal radiation) to electricity via photons (light). Such systems may be referred to as TPV generating systems.

The TPV generating systems described here generally include four components: a heat source, an emitter, a thermophotovoltaic (TPV) cell with a low bandgap, and a cooling system. Heat from the heat source, when applied to the emitter, can generate thermal radiation that can be received by the TPV cell and converted to electricity. The cooling system can function to reduce the temperature of the TPV device, such as to increase its efficiency.

FIG. 1 is a schematic cross-sectional view of an example aircraft propulsion system 10 (which may also be referred to as “engine 10”) according to the present disclosure. As shown in FIG. 1, the aircraft propulsion system 10 defines an axial direction extending parallel to a longitudinal centerline or axis 22 provided for reference. The aircraft propulsion system 10 also defines a circumferential direction. The aircraft propulsion system 10 may be incorporated into an airplane, a drone (such as an unmanned aerial vehicle (UAV)), or any other manned or unmanned aerial vehicle or system. The propulsion system 10 extends axially along the centerline 22 between a forward upstream end 24 of the propulsion system 10 and an aft downstream end 26 of the aircraft propulsion system 10. The axis 22 may be a centerline axis of the aircraft propulsion system 10 and/or one or more of its components. The axis 22 may also or alternatively be a rotational axis of one or more components of the propulsion system 10. The propulsion system 10 may have different configurations, such as open rotor puller/pusher, forward/reverse core, offset/angles core, ducted/unducted, etc.

The aircraft propulsion system 10 can include a compressor section 32, a combustor section 34, a turbine section 36, and an exhaust section 37. The compressor section 32 includes a low pressure compressor (LPC) section 32A and a high pressure compressor (HPC) section 32B. The turbine section 36 includes a high pressure turbine (HPT) section 36A and a low pressure turbine (LPT) section 36B. Though not shown, in some embodiments, the turbine section may include a power turbine (PT) section that drives an additional power shaft. The aircraft propulsion system 10 can also include a low speed shaft 92 and a high speed shaft 96 that are rotatable. The LPC section 32A, the HPC section 32B, the combustor section 34, the HPT section 36A, and the LPT section 36B may collectively form part or all of a gas turbine engine core 40.

In the illustrative example, the engine sections 32A, 32B, 34, 36A, 36B, and 38 are arranged sequentially along the axis 22 between the upstream end 24 and the downstream end 26. With this arrangement, each engine section 32A, 32B within the compressor section 32 can be arranged axially along the axis 22. More particularly, the compressor section 32 can be arranged axially between the upstream end 24 and the combustor section 34. Note, however, that other configurations are within the scope of this disclosure, such as a reverse flow engine, an off-axis core with one or more components of the core engine on an axis angled from the axis 22, and/or the like. The exhaust section 37 can be arranged axially along the axis 22 aft of the LPT section 36B. The engine sections 32A, 32B, 34, 36A, 36B, and 38 can be housed within a stationary housing (referred to as a “propulsion system housing” or “engine housing”) 78 of the aircraft propulsion system 10. The propulsion system housing 78 can include a core engine case 80 (such as a core case) and a nacelle 82.

The core engine case 80 can house one or more of the propulsion system sections 32A-36B. Each of the engine sections 32A and 32B of the compressor section 32 and the engine sections 36A and 36B of the turbine section 36 can include a bladed rotor 84, 86, 88, and 90, respectively. The LPC section 32A can include one or more low pressure compressor (LPC) rotors 84a, and the HPC section 32B can include one or more high pressure compressor (HPC) rotors 86. The HPT section 36A can include one or more high pressure turbine (HPT) rotors 88, and the LPT section 36B can include one or more low pressure turbine (LPT) rotors 90. Each of the bladed rotors 84, 86, 88 and 90 can be configured as a ducted rotor internal within the aircraft propulsion system 10. That is, each of the bladed rotors 84, 86, 88 and 90 may be a ducted and/or shrouded engine rotor. Each of these bladed engine rotors 84, 86, 88, and 90 can include a rotor base (such as a disk or a hub) and a plurality of rotor blades (such as airfoils, vanes, etc.). The rotor blades are arranged circumferentially around the respective rotor base and the axis 22 in an array. The rotor blades may also be arranged into one or more stages longitudinally along a core engine airflow path 101. Each of the rotor blades is connected to the respective rotor base, and each of the rotor blades projects radially (such as spanwise) out from the respective rotor base into the core engine airflow path 101 and to a distal tip of the respective rotor blade. The core case 80 can extend axially along (such as axially overlaps) and extend circumferentially about (such as circumscribes) the engine sections 32A-36B and their respective bladed rotors 84, 86, 88, and 90. The core engine case 80 may also house a drivetrain including a gearbox not shown in FIG. 1.

The LPC rotor 84 can be coupled to and rotatable with the LPT rotor 90. For example, the LPC rotor 84 can be connected to the LPT rotor 90 through the low speed shaft 92. The LPC rotor 84, the LPT rotor 90, and the low speed shaft 92 may collectively form part or all of a low speed rotating assembly 94, such as a low speed spool of the core engine 40. This low speed rotating assembly 94 and its members 84, 90 and 92 can be rotatable about the axis 22, or the low speed rotating assembly 94 may be rotatable about another axis radially and/or angularly offset from the axis 22.

The HPC rotor 86 can be coupled to and rotatable with the HPT rotor 88. For example, the HPC rotor 86 can be connected to the HPT rotor 88 through the high speed shaft 96. The HPC rotor 86, the HPT rotor 88, and the high speed shaft 96 may collectively form part or all of a high speed rotating assembly 98, such as a high speed spool of the core engine 40. This high speed rotating assembly 98 and its members 86, 88 and 96 can be rotatable about the axis 22, or the high speed rotating assembly 98 may be rotatable about another axis radially and/or angularly offset from the axis 22.

The nacelle 82 can house and provide an aerodynamic cover over the core engine case 80. An exterior wall 82A of the nacelle 82 can be disposed radially outboard of, extend axially along (such as axially overlaps), and extend circumferentially about (such as circumscribes) the core engine 40 and its case 80. With this arrangement, the bladed rotors 84, 86, 88, and 90 can be disposed within the propulsion system housing 78.

During operation of the aircraft propulsion system 10, the engine core airflow 101 can flow through an airflow inlet 104 of the core engine 40 (the core engine airflow path). The air entering the core engine airflow path 101 may be referred to as “core air”. The core engine airflow path can extend longitudinally in the core engine 40 from the airflow inlet 104 sequentially through the LPC section 32A, the HPC section 32B, the combustor section 34, the HPT section 36A, and the LPT section 36B.

The core air 101 can be compressed by the LPC rotor(s) 84 and the HPC rotor(s) 86 and directed into a combustion chamber 16 (such as an annular combustion chamber) of a combustor (such as an annular combustor) in the combustor section 34. Fuel can be injected into the combustion chamber 16 and mixed with the compressed core air 101 to provide a fuel-air mixture. This fuel-air mixture can be ignited and used to generate a high-temperature combustion gas flow 101A. A first portion 101B of the high-temperature combustion gas flow 101A can flow through and sequentially drive rotation of the HPT rotor(s) 88 and the LPT rotor(s) 90. The rotation of the HPT rotor(s) 88 and the LPT(s) rotor 90 can respectively drive rotation of the HPC rotor(s) 86 and the LPC rotor(s) 84 and, thus, compression of the air received from the airflow inlet 104.

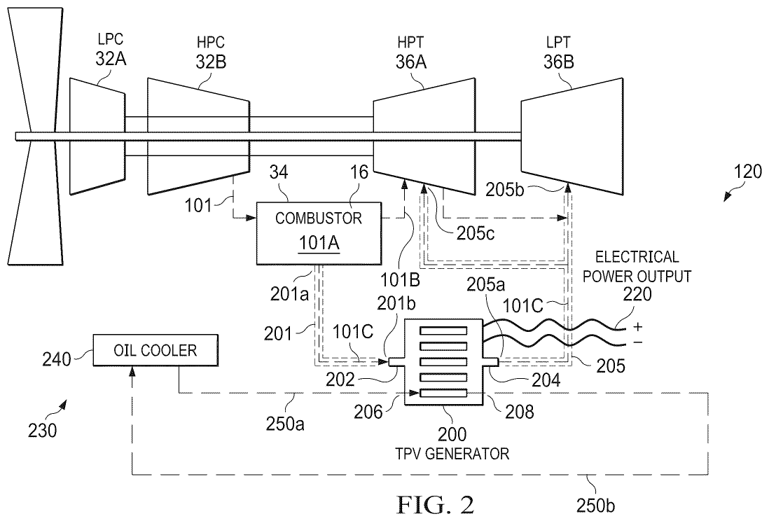

The aircraft propulsion system 10 can include a thermoelectric generating system 120 (which may also be referred to as a “TPV generating system”). As shown in FIGS. 1 and 2, the TPV generating system 120 can receive a second portion 101C of the high-temperature combustion gas flow 101A generated in the combustor section 34 (or chamber 16). As will be appreciated, the second portion 101C of the combustion gas flow 101A is diverted (or redirected) from flowing directly to the downstream HPT rotor(s) 88. Instead, the second portion 101C exits the combustion chamber 16 and is directed to the TPV generating system 120. This high-temperature combustion gas flow 101C (shown in FIG. 2) can provide the operational heat source for the TPV generating system 120. Although not shown in FIG. 1, the TPV generating system 120 can include a cooling system and a TPV generator having one or more TPV cells.

FIG. 2 is a schematic diagram of the aircraft propulsion system 10 with an electric power generating system according to the present disclosure. As shown in FIG. 2, the TPV generating system 120 includes one or more flow conduits 201 (e.g., thermal piping) shown in dotted lines and a TPV generator 200 configured to receive (via the flow conduit(s) 201) the high-temperature combustion gas flow 101C from the combustion section 34 (heat source) at an input port 202 and output electrical power 220. The combustion chamber 16 is structured and configured with a path or passageway enabling the flow 101C to exit the combustion chamber 16 and flow into the flow conduit(s) 201. The flow conduit(s) 201 includes a first end 201a configured to receive the flow 101C as it exits the combustion chamber 16 and carry the flow 101C to a second end 201b coupled to the input port 202. It will be understood that the flow conduit(s) 201 may have any desired and suitable shape, size and configuration depending on the location and positioning of the TPV generator 200 with respect to the combustion chamber 16. The flow conduit(s) 201 can be constructed of one or more high temperature capable (tolerant) materials suitable to carry the high temperature combustion gas flow 101C, and in some embodiments may range on the order of 1000-1300 degrees Celsius.

As the high-temperature combustion gas 101C flows through conduits in the TPV generator 200, it provides heat to the conduit walls and to surfaces of emitter sources (or structures) of the TPV generator 200. The TPV cells are also coupled to heat exchangers. Heat is extracted from the TPVs and transferred to fluid inside the heat exchangers. After flowing through the TPV generator 200 to an output port 204, the combustion gas 101C can return to the turbine section 36 (36B and/or 36A) for additional power extraction. This return path can be provided by one or more output flow conduits 205 (shown in dotted lines). The flow conduit(s) 205 includes a first end 205a coupled to the output port 204 and configured to receive the flow 101C as it exits the TPV generator 200 and carry the flow 101C to either a second end 205b coupled to the LPT section 36B or another end 205c coupled to the HPT section 36A, or to both the HPT and LTP sections. It will be understood that the flow conduit(s) 205 may have any desired and suitable shape, size and configuration depending on the location and positioning of the TPV generator 200 with respect to the LPT section 36B. The flow conduit(s) 205 can be constructed of one or more high temperature capable (tolerant) materials suitable to carry the high temperature combustion gas flow 101C, and in some embodiments may range on the order of 600-900 degrees Celsius.

The TPV generating system 120 also includes a cooling system 230 having a fluid cooling device 240 configured to supply a heat exchange fluid 250 for input to the TPV generator 200. In operation, the fluid 250a (at a lower temperature) supplied by the cooling device 240 can be input to the TPV generator 200 at a cooling input port 206 and circulated therein, which provides a heat exchanging function for cooling (reducing or maintaining the temperature of) certain internal components such as TPV cells. As the fluid 250a circulates through the TPV generator 200 from the input port 206 to an output port 208, it absorbs heat, causing its temperature to rise. From the output port 208, the fluid 250b (at a higher temperature) returns to the cooling device 240. Although not shown, it will be understood that the cooling device 240 may also be configured to reduce the temperature of the return fluid 250b and thereafter recirculate the lower-temperature fluid 250a back to the TPV generator 200. The fluid 250 may be gas or liquid, such as oil or other heat transferring fluid. Any suitable fluid cooling device 240 and fluid 250 now known or later developed may be utilized. In one embodiment, ambient air from the surrounding environment it utilized to cool the return fluid 250b.

In other embodiments, the cooling system 230 may be configured to include a network of pipes or airflow passages (not shown) which receive cold ambient air from the surrounding environment (e.g., at high altitude) and direct and utilize this cold ambient air as the fluid 250a to the input port 206 of the TPV generator 200, and receive the fluid 250b from the output port 208 for discharge into the surrounding environment.

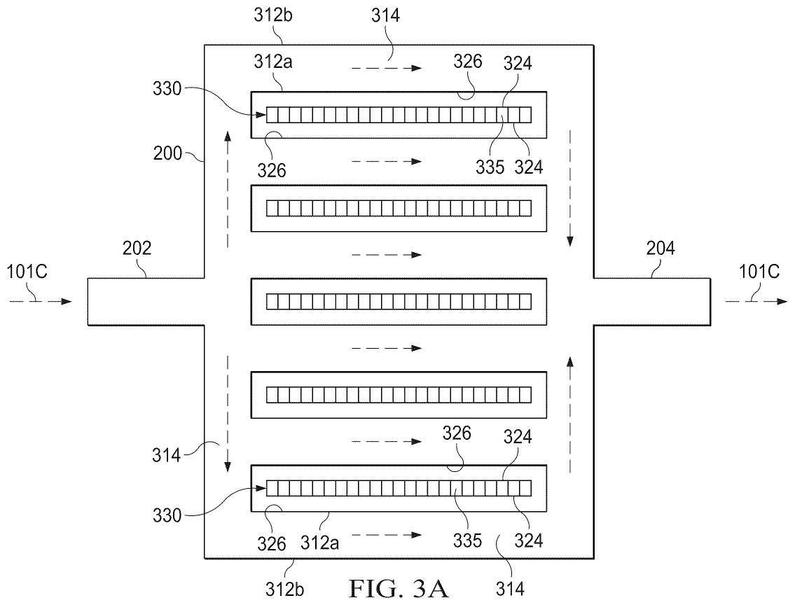

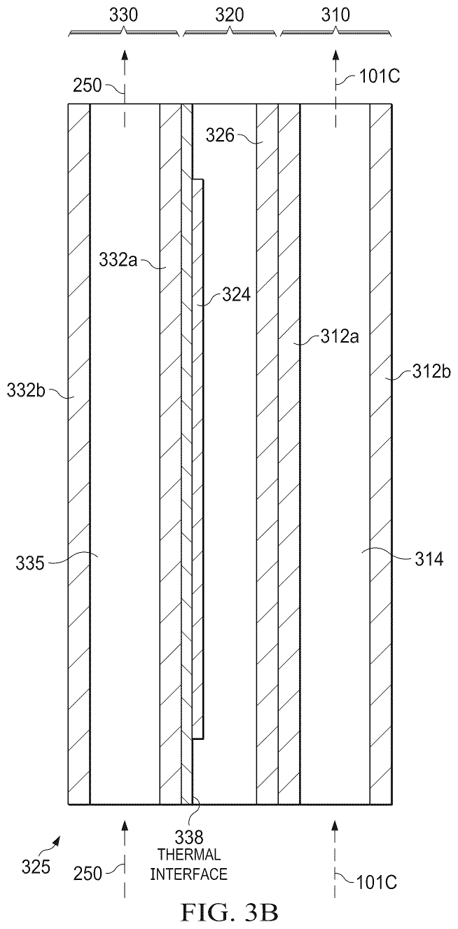

FIGS. 3A and 3B are side and cross-sectional views of an example TPV generator 200 in accordance with the present disclosure. In general, the TPV generator 200 includes a hot section 310 (sometimes referred to as “heat source”), an emitter/TPV cell section 320, and a cold section 330 (sometimes referred to as “heat exchanger”). The hot section 310 can transfer heat from the high-temperature combustion gas 101C (generally in the range of 1000-1200 degrees Celsius) to the emitter/TPV cell section 320. The hot section 310 can include a plurality of walls 312a, 312b that form a plurality of conduits, ducts, passageways, or pathways (referred to generally as “conduits”) 314 through which the high-temperature combustion gas 101C may flow from the input port 202 to the output port 204. In the example shown in the FIGURES, heat can be transferred (by radiation, convection and/or conduction) from the walls 312a of the conduits 314 to the emitter sources 326 of the emitter/TPV cell section 320. The heat causes the emitter sources to emit thermal infrared radiation, including photons, which are absorbed by the cells, directly converting emitted photons to electric potential. The walls 312a of the conduits 314 can be constructed of one or more high temperature capable (tolerant) materials having high thermal transfer properties, such as one or more metals, to enable heat from the combustion gas 101C to readily flow through the conduit walls 312a of the conduits 314 towards the emitter sources of the emitter/TPV cell section 320. The walls 312b of the conduits 314 can be constructed of the same material(s) as the walls 312a, or may have one or more high temperature capable (tolerant) materials but with low thermal transfer properties, such as one or more metals and insulative materials, to reduce heat loss though the conduit walls 312b of the conduits 314.

The emitter/TPV cell section 320 can convert heat received from the hot section 310 into electric power. For example, the emitter/TPV cell section 320 can include one or more emitter structures 326 and one or more TPV cells 324 The emitter structure 326 can generate and emit thermal radiation at one or more specified or desired wavelengths in response to heat received/applied to the emitter structure 326. The TPV cell 324 can capture or absorb the emitted thermal radiation and convert it to electricity. The TPV cell 324 may be constructed of discrete components or formed as an integrated component. Any suitable materials now known or later developed may be used for the emitter structure 326 (such as silicon carbide, tungsten, rare-earth oxides, and/or photonic crystals) and for the TPV cell 324 (such as silicon, germanium, gallium, antimonide, arsenide, phosphide, indium, and combinations thereof, as well as various combinations of lead, tin, strontium, and selenide). Although grey/black body emitter materials may be utilized, materials with selective emissivity (a selective emitter) are preferred for efficiency purposes, and those selective emitters able to handle or withstand the high temperature environment as intended are further preferred. In embodiments, the emitter structure 326 may formed of a spectrally selective material or finish applied to surfaces of the conduit walls 312. Additional components may be incorporated, including filters, concentrators or other power or efficiency enhancing components as known to those skilled in the art.

The cold section 330 (sometimes also referred to as a heat exchanger) can transfer heat from the emitter/TPV cell section 320 to the cooling fluid 250. The cold section 330 can include a plurality of walls 332a, 332b that form a plurality of conduits, ducts, passageways, or pathways (referred to generally as “conduits”) 335 through which the cooling fluid 250 flows from the input port 206 to the output port 208. Heat can be transferred from the walls 332a of the conduits 335 to the cooling fluid 250. In addition, heat may be transferred from the walls 332a and/or 332b to other thermally-conductive structures, such as cooling fins (not shown) that may be integrated with the conduits 335 or disposed in thermal contact therewith. The walls 332a, 332b of the conduits 335 (and the cooling fins if utilized) can be constructed of one or more materials having high thermal transfer properties, such as one or more metals, to enable heat proximate the TPV cell 324 to readily flow through the walls 332a, 332b of the conduits 335 to the cooling fluid 250 and optionally the cooling fins for transfer into the surrounding environment. In some cases, the cold section 330 may include a thin layer of material (thermal interface material (TIM)) 338 disposed between the TPV cell 324 and the conduit wall 332a of the conduits 335 to assist in thermal transfer. Any TIMs suitable for the temperature range and environment may be utilized, such as thermal grease and phase change materials (PCMs) with high thermal conductivity properties, for efficient transfer of heat from the TPV cells to the cold section 330. Any suitable thickness of the material 338 may be used for the desired effect, such as for example thicknesses ranging from about 0.5 to 3 millimeters.

In the configuration shown in FIGS. 3A and 3B, the conduits 314 can include a plurality of parallel conduits (such as six conduits) extending from the input side at one end to the output side at the other end. Also, the conduits 335 can include a plurality of parallel conduits (such as nineteen conduits) formed as a single group and may further include a plurality of parallel groups of conduits (such as five groups). The conduits 334 may extend from one end of the TPV generator 200 to another end. In some cases, the conduits 335 may be disposed perpendicular to the parallel conduits 314. As will be appreciated, any suitable number, configuration, and orientation of conduits 314 and conduits 335 may be utilized and implemented as needed or desired.

In some embodiments, the TPV generator 200 can include a plurality of TPV stacks. Each TPV stack can include or be associated with a hot section 310, an emitter/TPV cell section 320, and a cold section 330. In particular embodiments, each TPV stack can include an emitter/TPV cell section 320, and each TPV stack can share a hot section 310 and/or a cold section 330 with at least one other TPV stack. In the example of FIG. 3A, ten TPV stacks are shown, where two adjacent stacks share a cold section 330 and two adjacent stacks share a hot section 310. As will be appreciated, any suitable number and size(s) of TPV stacks may be included in the TPV generator 200, which can vary depending (among other things) on the desired operating specifications and performance of the TPV generator 200.

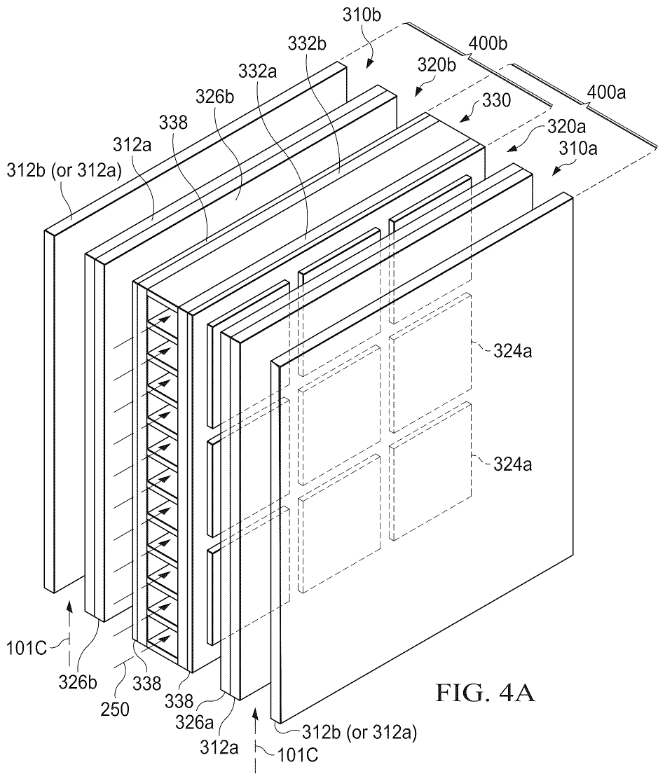

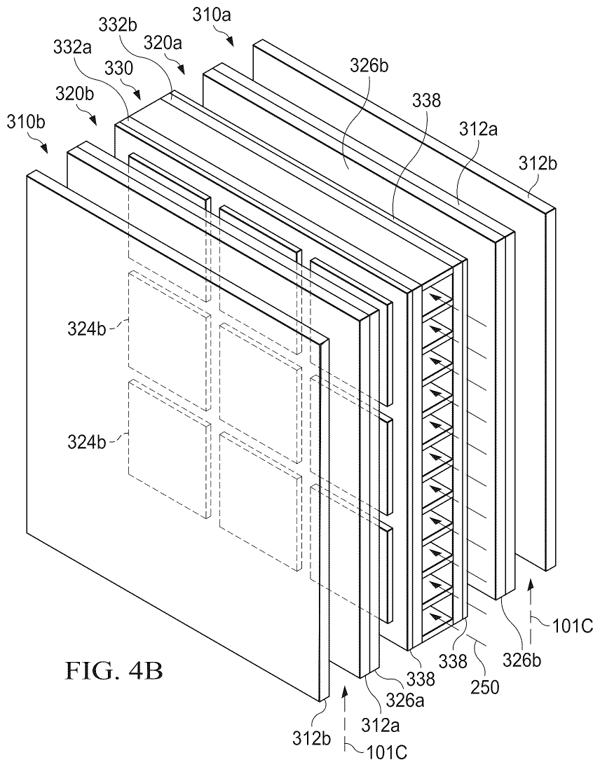

FIGS. 4A and 4B are right and left perspective side views illustrating two adjacent TPV stacks 400a-400b within the TPV generator 200 according to the present disclosure. As shown in FIGS. 4A and 4B, one TPV stack 400a can include a first hot section 310a, a first emitter/TPV cell section 320a, and a cold section 330x, and another TPV stack 400b can include a second hot section 310b, a second emitter/TPV cell section 320a, and the cold section 330x. As will be appreciated, the first cold section 330x is shared among both stacks 400a-400b. Such double stacking configurations can provide spatial and cost efficiencies, although this is not necessary to obtain the intended benefits of the TPV generating system 120 in accordance with the present disclosure. As will be appreciated, the TPV generator 200 shown in FIG. 3B includes the following sections (in the direction from the top to bottom): 310-320-330-320-310-320-330-320-310-320-330-320-310-320-330-320-310-320-330-320-310. In this example, the TPV generator 200 includes six hot sections 310, ten TPV cell sections 320, and five cold sections 330.

In other embodiments (not shown in the FIGURES), the walls 312a of the hot sections 310 may be constructed and function as the emitter source without an associative filtered surface 326. In other words, the wall of the hot section functions as the emitter to radiate photons towards the TPV cell 324, in response to the heat transferred from the flow 101C to the walls 312a. In these embodiments, the walls 312a can be constructed of one or more materials having photon emissivity properties, as well as having the mechanical strength and high temperature tolerance required to carry the high temperature combustion gases 101C. One potential material that may be utilized may be nickel and nickel alloy materials.

Although not shown in the figures, the electrical power output 220 from the TPV generator 200 of the TPV generating system 120 may be coupled to and provide electrical power to one or more systems in an aircraft. In some cases, the electrical power output 220 can be coupled to one or more batteries for charging and storage of power for later and/or current use in an aircraft.

In general terms, the present disclosure provides that heat is collected from a combustion process (e.g., aircraft engine) and re-routed or redirected through a thermal piping network to a TPV generator 200 to generate electric power. The heat applied to the emitter produces photonic radiation (e.g., infrared or other predetermined wavelength(s)) which is absorbed by a TPV cell to generate electric power/potential. The TPV cells and associated hardware are thermally managed by a fluid cooled heat sink/exchanger.

In addition to the generation of electrical power, inclusion of the TPV generating system 120 in accordance with the present disclosure in aircraft engine propulsion system (e.g., jet engine) can provide an additional benefit. In typical and conventional aircraft propulsion systems, the turbine sections 36A, 36B downstream of the combustion section 34 require cooling in those sections due to the high turbine entry temperature (e.g., 1000-1400 degrees Celsius) of the combustion gas flow exiting the combustion section and entering the turbine section. In accordance with the present disclosure, the temperature of the flow 101C directed to the TPV generating system 120 is substantially reduced (e.g., to about 600-900 degrees Celsius) as it flows through the TPV generator 200. This reduced temperature flow 101C then mixes/recombines with the main flow 101B resulting in an overall temperature reduction (e.g., 800-1000 degrees Celsius) of the recombined flow 101 as it enters the turbine section 36B. As a result, less cooling (e.g., air bleed from compressor section) is required to cool the turbine rotor(s) 90 and other internal turbine components. This may reduce the air bleed requirements and increase efficiency.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

It may be advantageous to set forth definitions of certain words and phrases that may be used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A thermophotovoltaic (TPV) electric power generator comprising:
a first hot section configured to receive combustion gases from a combustion chamber of an engine and receive heat from the combustion gases;
a first emitter/TPV cell section thermally coupled to the first hot section and configured to receive and convert heat from the first hot section into electric power, the first emitter/TPV cell section including a plurality of thermal emitters configured to emit photonic energy and a plurality of TPV cells configured to receive and convert the photonic energy into electrical power through a series of junctions; and
a first cold section thermally coupled to the first emitter/TPV cell section and configured to extract heat from the first emitter/TPV cell section.

2. The TPV electric power generator in accordance with claim 1, wherein:
the first hot section comprises a first conduit configured to transport the combustion gases therethrough;
each of the plurality of thermal emitters is configured to emit photonic energy in response to thermal excitation at a bandgap within an electromagnetic spectrum that is within an operating bandgap range of the plurality of TPV cells; and
the first cold section comprises a second conduit configured to transport heat exchange fluid therethrough.

3. The TPV electric power generator in accordance with claim 2, wherein:
the first hot section, the first emitter/TPV cell section, and the first cold section form a first thermoelectric stack; and
the TPV electric power generator further comprises a second thermoelectric stack, the second thermoelectric stack comprising:
a second hot section configured to receive combustion gases and receive heat from the combustion gases, the second hot section comprising a third conduit configured to transport the combustion gases therethrough; and
a second emitter/TPV cell section thermally coupled to the first cold section and the second hot section and configured to receive and convert heat from the second hot section into electric power, the second emitter/TPV cell section including a plurality of thermal emitters and a plurality of TPV cells, the second emitter/TPV cell section thermally coupled to the second conduit of the first cold section.

4. The TPV electric power generator in accordance with claim 2, wherein:
the first hot section, the first emitter/TPV cell section, and the first cold section form a first thermoelectric stack; and
the TPV electric power generator further comprises a second thermoelectric stack, the second thermoelectric stack comprising:
a second emitter/TPV cell section thermally coupled to the first conduit and configured to receive and convert heat from the first hot section into electric power, the second emitter/TPV cell section including a plurality of thermal emitters and a plurality of TPV cells; and
a second cold section thermally coupled to the second emitter/TPV cell section and configured to extract heat from the second emitter/TPV cell section, the second cold section comprising a third conduit configured to transport heat exchange fluid therethrough.

5. The TPV electric power generator in accordance with claim 1, wherein:
the first hot section, the first emitter/TPV cell section, and the first cold section form a first thermoelectric stack; and
the TPV electric power generator further comprises a second thermoelectric stack, the second thermoelectric stack comprising:
a second hot section configured to receive combustion gases and receive heat from the combustion gases;
a second emitter/TPV cell section thermally coupled to the second hot section and configured to receive and convert heat from the second hot section into electric power, the second emitter/TPV cell section including a plurality of thermal emitters and a plurality of TPV cells; and
a second cold section thermally coupled to the second emitter/TPV cell section and configured to extract heat from the second emitter/TPV cell section.

6. The TPV electric power generator in accordance with claim 5, wherein the first cold section of the first thermoelectric stack functions as the second cold section of the second thermoelectric stack.

7. The TPV electric power generator in accordance with claim 5, wherein the first hot section of the first thermoelectric stack functions as the second hot section of the second thermoelectric stack.

8. An electric power generating system comprising:
a gas turbine engine having a combustion chamber configured to generate and output a first flow of combustion gases through a combustion gas conduit and a second flow of combustion gases; and
a thermophotovoltaic (TPV) electric power generator comprising:
a first hot section configured to receive via the combustion gas conduit the first flow of combustion gases and receive heat from the combustion gases;
a first emitter/TPV cell section thermally coupled to the first hot section and configured to receive and convert heat from the first hot section into electric power, the first emitter/TPV cell section including a plurality of thermal emitters comprising a spectrally selective material and configured to emit photonic energy and a plurality of TPV cells configured to receive and convert the photonic energy into electrical power; and
a first cold section thermally coupled to the first emitter/TPV cell section and configured to extract heat from the first emitter/TPV cell section.

9. The electric power generating system in accordance with claim 8, wherein:
the first hot section comprises a first conduit configured to transport the combustion gases therethrough;
each of the plurality of the thermal emitters is configured to emit photonic energy in response to thermal excitation at a bandgap within an electromagnetic spectrum that is within an operating bandgap range of the plurality of TPV cells; and
the first cold section comprises a second conduit configured to transport heat exchange fluid therethrough.

10. The electric power generating system in accordance with claim 9, wherein:
the first hot section, the first emitter/TPV cell section, and the first cold section form a first thermoelectric stack; and
the TPV electric power generator further comprises a second thermoelectric stack, the second thermoelectric stack comprising:
a second hot section configured to receive via the combustion gas conduit the first flow of combustion gases and receive heat from the combustion gases, the second hot section comprising a third conduit configured to transport the combustion gases therethrough; and
a second emitter/TPV cell section thermally coupled to the first cold section and the second hot section and configured to receive and convert heat from the second hot section into electric power, the second emitter/TPV cell section including a plurality of thermal emitters and a plurality of TPV cells, the second emitter/TPV cell section thermally coupled to the second conduit of the first cold section.

11. The electric power generating system in accordance with claim 9, wherein:
the first hot section, the first emitter/TPV cell section, and the first cold section form a first thermoelectric stack; and
the TPV electric power generator further comprises a second thermoelectric stack, the second thermoelectric stack comprising:
a second emitter/TPV cell section thermally coupled to the first conduit and configured to receive and convert heat from the first hot section into electric power, the second emitter/TPV cell section including a plurality of thermal emitters and a plurality of TPV cells; and
a second cold section thermally coupled to the second emitter/TPV cell section and configured to extract heat from the second emitter/TPV cell section, the second cold section comprising a third conduit configured to transport heat exchange fluid therethrough.

12. The electric power generating system in accordance with claim 8, wherein:
the first hot section, the first emitter/TPV cell section, and the first cold section form a first thermoelectric stack; and
the TPV electric power generator further comprises a second thermoelectric stack, the second thermoelectric stack comprising:
a second hot section configured to receive via the combustion conduit the first flow of combustion gases and receive heat from the combustion gases;
a second emitter/TPV cell section thermally coupled to the second hot section and configured to receive and convert heat from the second hot section into electric power, the second emitter/TPV cell section including a plurality of thermal emitters and a plurality of TPV cells; and
a second cold section thermally coupled to the second emitter/TPV cell section and configured to extract heat from the second emitter/TPV cell section.

13. The electric power generating system in accordance with claim 12, wherein the first cold section of the first thermoelectric stack functions as the second cold section of the second thermoelectric stack.

14. The electric power generating system in accordance with claim 12, wherein the first hot section of the first thermoelectric stack functions as the second hot section of the second thermoelectric stack.

15. The electric power generating system in accordance with claim 8, further comprising:
a cooling system configured to receive heat exchange fluid from the first cold section, lower a temperature of the heat exchange fluid to generate cooled heat exchange fluid, and supply the cooled heat exchange fluid to the first cold section.

16. The electric power generating system in accordance with claim 8, wherein:
the gas turbine engine comprises a core engine defining an engine airflow path; and
the core engine comprises a spool section having a compressor, a combustion section comprising the combustion chamber, a turbine, and a spool shaft coupled to the compressor and the turbine.

17. The electric power generating system in accordance with claim 8, wherein:
the gas turbine engine comprises a spool section having a compressor, a combustion section comprising the combustion chamber, a turbine, and a spool shaft coupled to the compressor and the turbine, the combustion chamber configured to generate the second flow of the combustion gases and output the second flow of combustion gases to the turbine.

18. A method comprising:
generating combustion gases in a combustion chamber of an engine;
diverting a first portion of the generated combustion gases from the combustion chamber;
receiving the first portion of generated combustion gases;
receiving heat from the received first portion of generated combustion gases;
converting, by a plurality of thermophotovoltaic (TPV) devices, received heat from the received first portion of generated combustion gases into electric power; and
extracting heat from the plurality of TPV devices.

19. The method of claim 18, further comprising:
emitting photonic energy from a thermal emitting material in response to thermal excitation caused by heat received from the received portion of generated combustion gases; and
converting the emitted photonic energy into electric power.

20. The method of claim 18, wherein extracting heat from the plurality of TPV devices further comprises:
receiving heat exchange fluid that contains heat extracted from the TPV devices;
lowering a temperature of the received heat exchange fluid to generate cooled heat exchange fluid; and
supplying the cooled heat exchange fluid to remove additional heat from the TPV devices.
